(19) United States
(12) Patent Application Publication
(10) Pub. No.: US 2023/0208727 A1
(43) Pub. Date: Jun. 29, 2023

(54) DATA INTEGRITY ILLUSTRATION AND EVALUATION SYSTEM AND METHOD

(71) Applicant: Rakuten Mobile, Inc., Tokyo (JP)

(72) Inventors: Vishvesh TRIVEDI, Tokyo (JP); Anshul BHATT, Tokyo (JP); Dhananjay CHAUBEY, Tokyo (JP); Alok Singh PAWAR, Madhya Pradesh (IN); Manish PATIDAR, Madhya Pradesh (IN)

(21) Appl. No.: 17/564,053

(22) Filed: Dec. 28, 2021

(51) Int. Cl. H04L 41/22

(52) U.S. Cl. CPC H04L 41/22

(57) ABSTRACT

A method includes causing a graphical user interface to be output by a display. The graphical user interface includes first, second and third user input fields configured to receive a first user input identifying a network service provider name identifying a selected network service provider associated with providing one or more network services to a communication network, a second user input identifying a selected wireless domain, and a third user input identifying a selected wireless technology. The method also includes processing the selected network service provider name, the selected wireless domain and the selected wireless technology to generate an illustration profile. The method further includes processing an instruction to view system data associated with the one or more network service provided to the communication network to cause a graphical view of the system data to be displayed based on the illustration profile.

### BACKGROUND

Network operators, network service providers and device manufacturers (e.g., wireless, cellular, etc.) are continually challenged to deliver value and convenience to consumers by, for example, providing compelling communication networks and network services that are dependable and capable of being flexibly constructed, scalable, diverse, and economically operated. To provide such communication networks and network services, network operators, network service providers and device manufacturers often track key performance indicators (KPI's) that are indicative of an operating state of a communication network and/or various network services and/or network devices.

### BRIEF DESCRIPTION OF DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a diagram of a data integrity illustration and evaluation system that facilitates illustrating and evaluating data integrity corresponding to a network service provided to a communication network by a network service provider, in accordance with one or more embodiments.

FIG. 2 is a diagram of a graphical user interface, in accordance with one or more embodiments.

FIG. 3 is a diagram of a graphical user interface, in accordance with one or more embodiments.

FIG. 4 is a diagram of a graphical user interface, in accordance with one or more embodiments.

FIG. 5 is a flowchart of a process for illustrating and evaluating data integrity corresponding to a network service provided to a communication network by a network service provider, in accordance with one or more embodiments.

FIG. 6 is a functional block diagram of a computer or processor-based system upon which or by which some embodiments are implemented.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation or position of a first feature over or on a second feature in the description that follows may include embodiments in which the first and second features are formed or positioned in direct contact, and may also include embodiments in which additional features may be formed or positioned between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of an apparatus or object in use or operation in addition to the orientation depicted in the figures. The apparatus may be otherwise oriented (rotated 90 degrees or at other orientations) and the spatially relative descriptors used herein may likewise be interpreted accordingly.

Communication networks and network services are often provided by static or inflexible systems that are difficult to configure, scale, and deploy over various target areas. Dependable provision of communication networks and/or network services that are capable of being flexibly constructed, scalable and diverse is often reliant on the collection, analysis and reporting of information regarding multiple network functions, network services, network devices, etc. that affect the performance, accessibility, configuration, scale, and/or deployment of a communication network, various network functions, network services, and the like.

Network service providers often deploy network monitoring systems that track various key performance indicators (KPI's) of an aspect of network for determining how well that aspect and/or the network is performing. KPI's are often KPI values and/or trends that are compared to certain thresholds to indicate the relative performance of a communication network, network service, network device, etc. The KPI values are often based on monitoring data referred to herein as system data or historical performance data.

Sometimes, when a KPI value for a certain network function, network service or feature is below a preset threshold, the KPI value may imply that the network is operating normally, whereas when the KPI value is above or equal to the preset threshold, the KPI value implies that the network is operating below expectation, which in turn may indicate that some unexpected event (e.g., a hardware failure, capacity overload, a cyberattack, etc.) has occurred. Accordingly, a series of actions can be carried out by the network monitoring system such as alerting the network operator, shifting a network function from a problematic server to a healthy server, temporarily shutting down the network, or some other suitable action. Of course, depending on the network configuration, a condition in which the KPI value is higher than or equal to a threshold can also indicate that the network is operating normally, while a condition in which the KPI value is below the threshold indicates that the network is operating below expectation. Several other types of threshold configurations are possible as the threshold configurations may vary depending on the needs of a specific user or specific network operator, depending on individual preference, type of KPI being monitored, type of KPI created by a user for monitoring, type of system data that is processed for monitoring a KPI, and the like.

Network operators often coordinate and deploy communication networks that include network services (e.g., hardware, software, etc.) that are provided by one or more network service providers. Each network service provider often uses a corresponding monitoring system to monitor performance of the network service(s) provided by that network service provider to gather various system data (e.g., raw data, processed data, raw data provided by a network service provider's monitoring system, KPI data pre-processed by the network service providers, etc.) usable for determining KPI values indicative of the state of the communication network. The network service providers send the system data to the network operator for monitoring the status of the communication network in consideration of the system data associated with the network service(s) provided by each network service provider. For example, the network operator uses the system data supplied from the network service providers to generate KPI value and/or to evaluate the quality of services provided by each of the network service providers.

Prior to sending the system data, the network service providers and the network operators often agree regarding how much system data each network service provider's monitoring system will send to the network operator, and how frequently the system data will be sent. Ideally, the amount of system data received by the network operator is equal to the amount of system data informed/promised/agreed to by the network service provider. However, problems often arise due to various factors, and the amount of system data received by the network operator sometimes differs from the amount of system data that was informed/promised/agreed to be provided by the network service provider.

For example, data loss may occur during transmission of the system data due to environmental noise or a malfunction in the transmission medium (e.g., damage in a fiber optic channel, weak signaling, etc.). Further, issues in the monitoring system corresponding to a network service provider such as system delay, the monitoring system being offline, etc., may also be problematic. Additionally, a malfunction in the provision of a network service caused by hardware damage, software failure, etc., may be another reason for a difference between the amount of system data informed/promised/agreed to by the network service provider and that which is actually received by the network operator.

Network operators should consistently check the integrity and completeness of the system data provided by the various network service providers to facilitate prompt resolution of any possible issues in the provision of the communication network that may stem from poor quality of service that would be indicated by the expected system data to ensure validity and stability of the communication network. Thus, it is important for a network operator to identify discrepancies in the amount of system data informed/promised/agreed to by the network service provider and that which is actually received by the network operator, identify the cause, and take action regarding any arrangements with a particular network service provider regarding a failure to supply the expected system data or change network service providers or network devices that are used to provide one or more network services that are malfunctioning to one or more alternative network service providers and/or one or more alternative network devices to ensure the communication network is operations and available for consumers.

Communication networks implemented by way of several network services provided by different network service providers often involve different domains such as radio area network (RAN), core network, some other suitable domain, various software interfaces, devices, etc. that are proprietary and/or optimized by a specific network service provider. Thus, a network operator may desire to set a threshold value according to the amount of system data informed/promised/agreed to be provided by a specific network service provider to a set data amount and/or delivery timing such that when the amount of system data provided by the network service provider is different from the threshold value, the network operator is informed and can take appropriate action thereafter.

As the communication network evolves and improves, a single communication network may involve an ever-changing quantity of network service providers for providing network services and/or that are associated with providing network services associated with various aspects of the communication network (e.g., domains, technologies, locations of services, etc.) and, as a result, the state of the communication network may vary dynamically with the addition and/or subtraction of network service providers, a change in one or more network services, etc. For example, different network service providers may have different arrangements on the amount of system data and/or the method by which the system data is supplied to the network operator. On the other hand, one network service provider may provide multiple network services to a network operator in one arrangement, and for different network services the same network service provider may have different arrangements regarding the amount of system data and/or different methods by which the system data is supplied to the network operator. Further, according to a latest network status, different network service providers may need to arrange the amount of system data to-be sent to the network operator in a different manner.

Accordingly, monitoring the integrity and completeness of the system data provided by multiple network service providers becomes more challenging, and the conventional methods used by network operators to monitor the amount of system data provided by network service providers are inefficient, cumbersome and impractical to be used when attempting to monitor an ever growing, changing, and increasingly complex communication network implemented by combining network services provided by an ever changing quantity of network service providers.

Further, as the communication network evolves, the quantity of users involved with monitoring the state of the communication network increases. Ensuring that each user has satisfactory knowledge to accurately configure the communication network, therefore, becomes increasingly difficult.

For example, multiple administrators on a network operator side of a communication network may be responsible for monitoring data integrity and completeness for various network services provided by various network service providers. An administrator that is not familiar with a monitoring system used to monitor the status of the communication network and/or monitoring the integrity or completeness of system data provided by the various network service providers may configure the monitoring system in a manner that is less accurate as compared to another administrator that is familiar with the monitoring system. As another example, a new administrator may not know that a profile has already been created by another network administrator for monitoring one or more particular network services. Accordingly, the new administrator may create a redundant profile for monitoring the same one or more network services, which results in wasting system and/or network resources, and may cause a situation in which the network operator is sending duplicate alerts to a network service provider for an identified issue regarding a same one or more network services. Additionally, as the amount of system data increases significantly, because more information may be provided from the various network service providers for existing or newly implemented network services and/or new network service providers are providing system data for existing or newly implemented network services, lesser experienced administrators may find it difficult to quickly understand the system data provided by the network service providers, regardless of whether the system data is received in any predefined format or whether the system data is purely raw data that is unformatted or has a proprietary format corresponding to a specific network service provider.

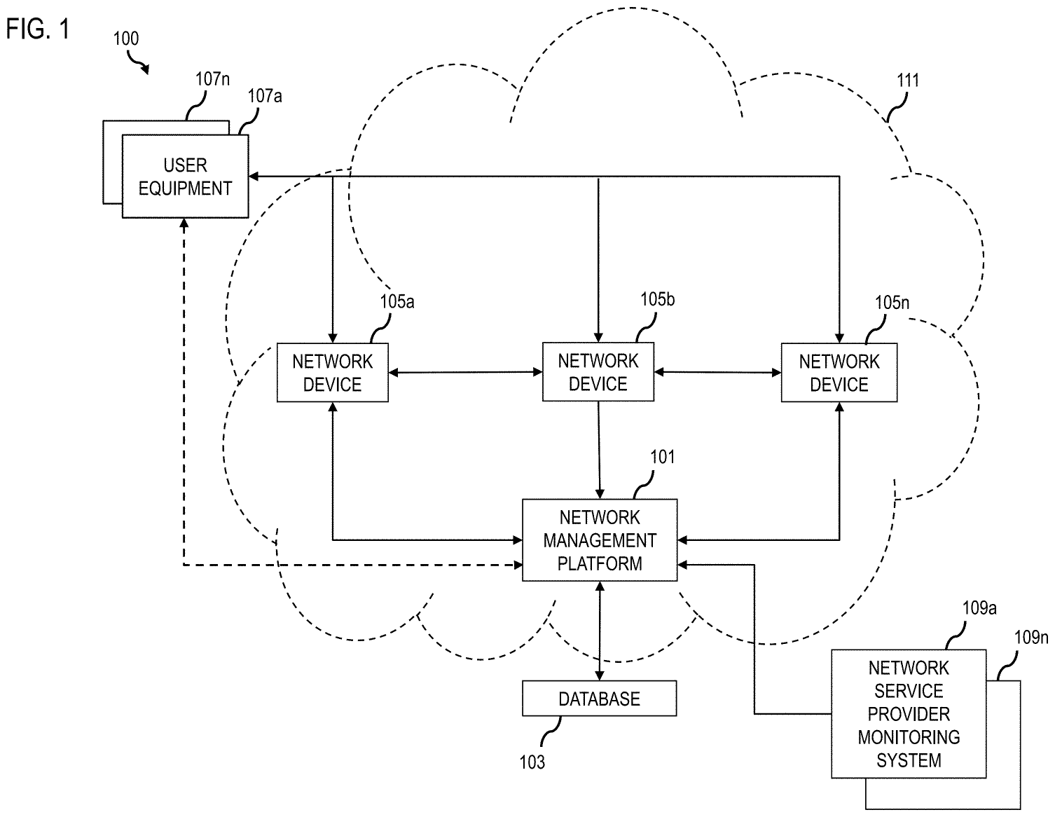

FIG. 1 is a diagram of a data integrity illustration and evaluation system 100 that facilitates illustrating and evaluating data integrity corresponding to a network service provided to a communication network by a network service provider, in accordance with one or more embodiments.

The system 100 makes it possible to improve a user's experience by simplifying the process of configuring and maintaining the system data monitoring profiles so as to lower the burden on the users configuring system data monitoring profiles and on those responsible for evaluating the integrity and completeness of the system data provided to a network operator by one or more network service providers, and allowing more users (e.g., network administrators, network service providers, etc.) to configure system data monitoring profiles associated with the system 100. In some embodiments, the system 100 is configured to facilitate continuous monitoring, evaluation, and/or illustration of the integrity and completeness of system data provided by multiple network service providers in a user's desired manner.

System 100 comprises a network management platform 101, a database 103, one or more network devices 105a-105n (collectively referred to as network devices 105), and one or more user equipment (UE) 107a-107n (collectively referred to as UE 107). The network management platform 101, the database 103, the one or more network devices 105, and/or the one or more user equipment (UE) 107 are communicatively coupled by way of a communication network 111. The communication network 111 is orchestrated by the network management platform 101 which combines a plurality of network services provided a network service provider via the network devices 105. In some embodiments, the network management platform 101 is a network orchestrator that implements the communication network 111. In some embodiments, the network management platform 101 is a portion of a network orchestrator that implements the communication network 111.

The network service providers associated with the network services provided via the network devices 105 have corresponding network service provider monitoring systems 109a-109n (collectively referred to as network service provider monitoring system 109). The network service provider monitoring systems 109 collect system data associated with the network services provided to communication network 111 and send that system data to the network management platform 101 in accordance with various agreements with the network operator to facilitate monitoring of the state of the communication network 111. In some embodiments, one or more of the network service monitoring systems 109 are communicatively coupled to the database 103 without the network management platform 101 intervening.

Network management platform 101 is configured to generate one or more illustration profiles and/or evaluation profiles based on a plurality of parameters input by a user to facilitate illustrating and/or evaluating the integrity and completeness of the system data received from the network service provider monitoring systems 109.

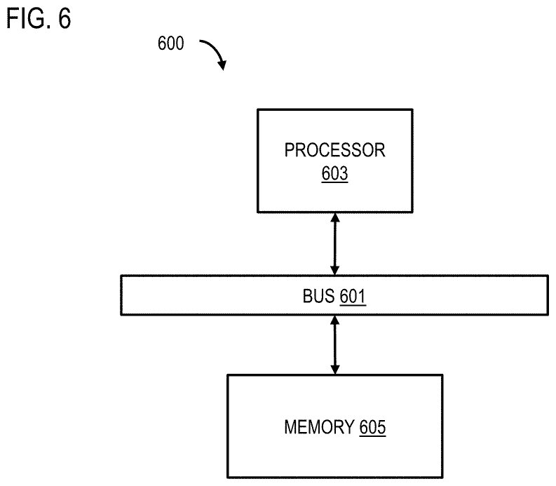

In some embodiments, network management platform 101 comprises a set of computer readable instructions that, when executed by a processor such as a processor 603 (FIG. 6), causes network management platform 101 to perform the processes discussed in accordance with one or more embodiments. In some embodiments, network management platform 101 is remote from the network devices 105. In some embodiments, network management platform 101 is a part of one or more of the network devices 105. In some embodiments, the network management platform 101 is divided among one or more of the network devices 105 and a processor remote from the network devices 105. In some embodiments, the network management platform 101 is at least partially implemented by a UE 107.

In some embodiments, database 103 is a centralized network repository having searchable information stored therein that includes historical system data, historical raw data, rules defining various KPIs, network functions capable of being implemented in the network involving one or more of network usage, timing, connected devices, location, network resource consumption, cost data, example network KPI's, KPI monitoring profiles corresponding to one or more users, KPI illustration profiles corresponding to one or more users, KPI evaluation profiles corresponding to one or more users, suitable element or information, or combination thereof. Database 103 is a memory such as a memory 605 (FIG. 6) capable of being queried or caused to store data in accordance with one or more embodiments. In some embodiments, the network management platform 101 and the database 103 together form a network orchestrator that implements the communication network 111. In some embodiments, the network management platform 101 and the database 103 together form a network orchestrator that implements the communication network 111.

In some embodiments, network management platform 101 generates a graphical user interface that is output to a display by way of a UE 107 or a terminal associated with network management platform 101 for a user (e.g., a network operator, a network administrator, and any personnel which would like to or is responsible to monitor the state of the communication network 111), so as to allow the user to input or select parameters for configuring an illustration profile and/or an evaluation profile for monitoring the integrity and completeness of system data received from a network service provider. Network management platform 101 generates the illustration and/or evaluation profile(s) specified by the user based on parameters input or selected by the user, and causes the generated profile(s) to be stored in database 103. In some embodiments, the user interface is accessible via a web browser such as by way of a website or a web browser plug-in. In some embodiments, network management platform 101 causes the generated illustration and/or evaluation profiles to be stored in a server, in a memory of a UE 107, or some other suitable location.

In some embodiments, the user interface output by UE 107 enables a user to select one or more target system data based on desired information (e.g., network service providers, type of domains, type of technologies, type of modules, type of messaging services, and/or some other suitable information). Subsequently, the user-selected configuration is stored as an evaluation profile, and the network management platform 101 continuously evaluates the integrity of data provided by the multiple network service providers based on the evaluation profile in real-time, and performs an action (e.g., sending alert to the network operator/network service provider, scheduling maintenance, etc.) based on the evaluation. In some embodiments, the network management platform 101 is configured to evaluate the integrity and completeness of the target system data on demand. In some embodiments, the user interface 107 also makes it possible for a user to configure how the target system data should be presented, to save the user-selected configuration as an illustration profile, and to output a graphical representation list (e.g., list, graph, chart, etc.) showing detailed information of each of the multiple received system data in real-time or on-demand.

In some embodiments, the network management platform 101 and database 103 are configured to be a centralized data integrity monitoring and evaluation system that is apart from, or included as component of a network orchestrator that implements the communication network 111, which is capable of continuously monitoring any system data provided by any network service providers involved in the communication network, evaluating the integrity of said system data, and performing an action based on the evaluation. In some embodiments, the network management platform 101 is configured to generate a list that comprises multiple instances of received system data in real-time, and cause a graphical representation to be output by way of user interface 107 showing detailed information of each of the multiple instance of received system data in real-time.

The network service provider monitoring system(s) 109 of each of the plurality of network service providers continuously monitor the status of their own corresponding network services and periodically send at predetermined times (e.g., every 5 minutes, every 15 minutes, every 30 minutes, etc.) the monitored system data to the network management platform 101. The network management platform 101 causes the monitored system data to be stored in database 103. In some embodiments, as discussed above, the monitored system data is sent directly to the database 103. In some embodiments, the database 103 is a centralized data storage which is controlled by the network operator. In some embodiments, the network management platform 101 checks the database 103 for newly received system data and/or retrieves system data stored in the database for illustration and/or evaluation as-needed for continuous, periodic, or on-demand monitoring.

The system data is communicated from the network service provider monitoring systems 109 to the network management platform 101 and/or the database 103 via one or more of enhanced messaging service (EMS), email messaging, data packet transmission, or some other suitable type of data transmission which is optionally the same or different among the plurality of network service providers.

In some embodiments, the network management platform 101 continuously monitors the system data received from the network service provider monitoring system(s) 109 by processing received system data that is stored in the database 103 and recording information about the received system data (e.g., the amount of system data received, the time of receipt, the network service provider from which the system data was received, the method by which the system data was received, a module associated with the system data, a domain associated with the system data, a technology associated with the system data, or some other suitable information or parameter).

In some embodiments, the network management platform 101 evaluates the received system data by searching and extracting a configured evaluation profile that is stored in a memory having connectivity to the network management platform 101, the database 103, or some other suitable memory after being configured by a user for monitoring and evaluating the received system data. The network management platform 101 compares the recorded information associated with the received system data with the information included in the evaluation profile and generates an output of the evaluation results. In some embodiments, the output of results comprises a list containing the recorded information, a graph containing details illustrating the recorded information regarding the received system data associated with a particular network service, for example, or some other suitable output usable for demonstrating the integrity and completeness of the received system data and/or causing an action to occur that changes an operating state of the communication network 111, changes network services, changes network devices, changes network service providers, or some other suitable action.

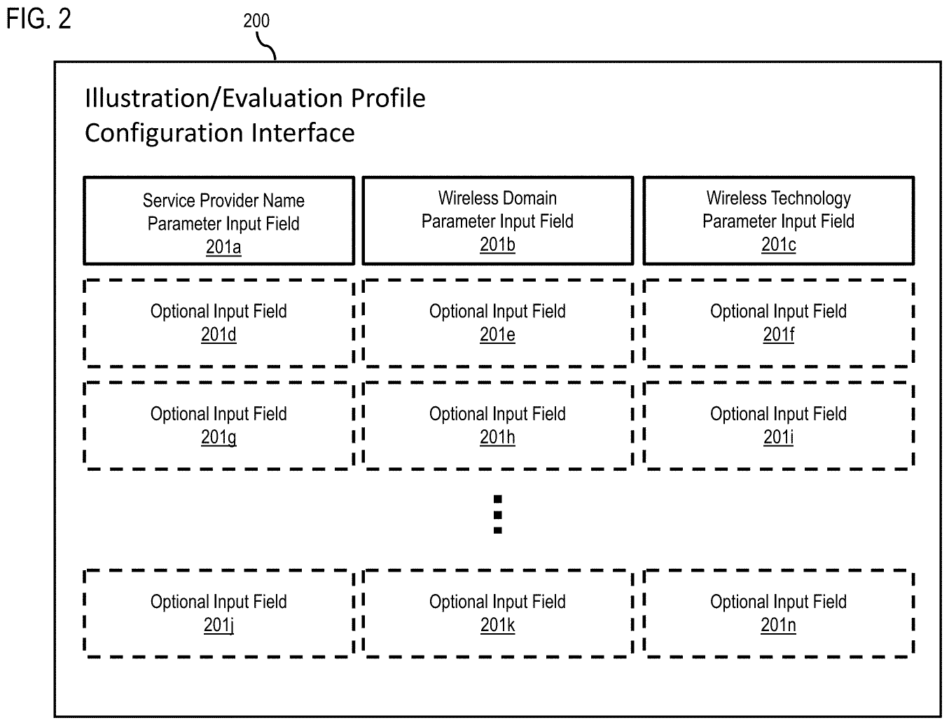

FIG. 2 is a diagram of a graphical user interface 200, in accordance with one or more embodiments. Network management platform 101 is configured to cause graphical user interface 200 to be output to a display. Graphical user interface 200 comprises a network service provider name input field 201a configured to receive a first user input identifying a network service provider name identifying a selected network service provider of a plurality of network service providers associated with providing a network service to a communication network (e.g., communication network 111), a wireless domain parameter input field 201b configured to receive a second user input identifying a selected wireless domain of a plurality of wireless domains, and a wireless technology parameter input field 201c configured to receive a third user input identifying a selected wireless technology of a plurality of wireless technologies. In some embodiments, one or more of user input fields 201a-201c is excluded from the graphical user interface 200.

In some embodiments, the graphical user interface 200 comprises one or more optional user input fields 201d-201n configured to receive one or more additional user inputs for designating one or more additional parameters associated with illustrating and evaluating system data integrity and completeness corresponding to a network service provided to a communication network by a network service provider.

For example, in some embodiments, the one or more optional user input fields 201d-201n optionally include a user input field configured to receive a user input identifying a quantity of values of the system data to be included in the graphical view. In some embodiments, the one or more optional user input fields 201d-201n optionally include a user input field configured to receive a user input identifying a period of time for illustrating the system data to be included in the graphical view. In some embodiments, the one or more optional user input fields 201d-201n optionally include a user input field configured to receive a user input identifying one or more types of graphs of the values of the system data over the period of time. In some embodiments, the different types of graphs include at least one of a pie graph, a bar graph, a histogram, a line plot, a frequency table, or some other suitable graphical or tabular presentation. In some embodiments, the one or more optional user input fields 201d-201n optionally include user input fields for receiving a user input that identifies two or more of the types of graphs to cause the two or more types of graphs to be concurrently displayed based on an instruction to view system data associated with the one or more network services provided to the communication network. In some embodiments, the one or more optional user input fields 201d-201n optionally include a user input field configured to receive a user input identifying an expected amount of system data associated with the one or more network services to be provided to the network management platform 101 by the selected network service provider. In some embodiments, the one or more optional user input fields 201d-201n optionally include a user input field configured to receive a user input identifying expected performance data values associated with the one or more network services at the corresponding times the values of the system data were received by the network management platform 101 and/or database 103 from the one or more network service provider monitoring systems 109. In some embodiments, the one or more optional user input fields 201d-201n optionally include a user input field configured to receive a user input identifying a period of time to monitor the amount of the system data associated with the one or more network services as the system data is received by the network management platform 101 and/or database 103 from the selected network service provider.

In some embodiments, the one or more optional user input fields 201d-201n optionally include a user input field configured to receive a user input identifying a variation threshold between the expected amount of the system data received by the network management platform 101 and/or database 103 from the selected network service provider and an actual amount of the system data received by the network management platform 101 and/or database 103 from the selected network service provider. In some embodiments, the one or more optional user input fields 201d-201n optionally include a user input field configured to receive a user input identifying a direction of deviation from the expected amount of the system data received by the network management platform 101 and/or database 103 from the selected network service provider and the actual amount of the system data received by the network management platform 101 and/or database 103 from the selected network service provider. For example, such a direction of deviation may include greater than, less than, equal to, or a combination thereof. In some embodiments, the one or more optional user input fields 201d-201n optionally include a user input field configured to receive a user input identifying a tolerance range of deviation from the expected amount of the system data received by the network management platform 101 and/or database 103 from the selected network service provider and the actual amount of the system data received by the network management platform 101 and/or database 103 from the selected network service provider. In some embodiments, the one or more optional user input fields 201d-201n optionally include a user input field configured to receive a user input identifying a geographical region within which the one or more network services are provided to the communication network to limit illustration and/or evaluation of the system data to the selected geographical region. In some embodiments, the one or more optional user input fields 201d-201n optionally include a user input field configured to receive a user input identifying one or more alert types caused to be output based on a determination that the actual amount of system data received by the network management platform 101 and/or database 103 from the selected network service provider breaches a variation threshold. In some embodiments, the one or more alert types comprise at least one of a text message, an email, a graphical image output to the display, a voice call, a pager message, or some other manner by which an alarm is capable of being communicated to a recipient. In some embodiments, the one or more optional user input fields 201d-201n optionally include a user input field configured to receive a user input identifying one or more recipients of the alert. In some embodiments, the one or more optional user input fields 201d-201n optionally include a user input field configured to receive a user input identifying a time range for outputting the alert. In some embodiments, the time range for outputting the alert is different from the period of time to monitor the actual amount of system data received. In some embodiments, the one or more optional user input fields 201d-201n optionally include a user input field configured to receive a user input identifying user credentials for creating and/or accessing an illustration and/or evaluation profile.

In some embodiments, one or more of the user input fields 201a-201n is configured to receive parameters manually input into the user input fields (e.g., via keyboard, voice control, and the like). Alternatively, the network management platform 101 causes one or more of the user input fields 201a-201d to provide (e.g., in the form of a drop-down list, pop-out window, auto-complete text, autocorrect text, radio buttons, or some other suitable options) available parameter options or parameters suggested by the network management platform 101 based on input or other inputted/selected parameters, and the user can simply select the available parameter options from the drop-down list, pop-out window, radio buttons, or other suitable options, or accept the auto-complete text or autocorrect text to fill the user input field 201a-201n. In some embodiments, the user can simply input a keyword(s) into one or more of the user input fields 201a-201n, and the network management platform 101 will then provide a drop-down list, pop-out window, radio buttons, etc. that comprise available and/or suggested parameters associated with the input keyword(s).

In some embodiments, the graphical user interface 200 is both an illustration profile configuration interface and an evaluation profile configuration interface. In some embodiments, the graphical user interface 200 is split into multiple displays, wherein one display is an illustration profile creation interface including at least those of user input fields 201a-201n associated with generating and illustrating the graphical and/or tabular outputs of the received system data according to the parameters that are input, and another display that is an evaluation profile creation interface separately displayed from the illustration profile creation interface which includes those of user input fields 201a-201n associated with generating the evaluation profile and causing alerts for detected deviations from the expected amount of system data.

In some embodiments, one or more of the user input fields 201a-201n included in the illustration profile creation interface and one or more of the user input fields 201a-201n included in the evaluation profile configuration interface are identical, appearing in separate graphical user interface displays for both the illustration profile creation interface and the evaluation profile creation interface.

In some embodiments, the network management platform 101 is configured to appropriately process information input into the various user input fields 201a-201n for purposes of generating the illustration profile and/or the evaluation profile in accordance with corresponding instructions directing the network management platform 101 to use which user input from which user input field 201a-201n for which purpose, and causes the illustration profile and the evaluation profile to be stored in the database 103.

The graphical user interface 200 enables a user to select and configure how the network management platform 101 should illustrate the system data provided by the network service providers. The user inputted configuration will be saved in the illustration profile. Subsequently, the selected data will be presented to the user in the form of a graphical representation based on the illustration profile. In some embodiments, when new system data is received for a selected network service by the network management platform 101 and/or determined by the network management platform 101 to be stored in database 103, the network management platform 101 automatically retrieves the updated system data from the database 103 based on the illustration profile, and then updates the graphical representation based on the updated data and the illustration profile. Accordingly, the network management platform 101, in some embodiments, is configured to provide a graphical representation which continuously monitors and illustrates the received system data in real-time. In some embodiments, if the graphical output comprises a tabular form or list, information in the table or list will also update periodically based on the illustration profile created by the user.

Similar to creating an illustration profile, the user can configure the way the network management platform 101 evaluates the data provided by the network service providers, by inputting the desired configuration via the user interface 200, or another user interface similar to user interface 200, but comprising user input fields for inputting and/or selecting optional parameters provided by the network management platform 101 that are associated with evaluating the integrity and completeness of the system data received from the network service providers.

To generate the evaluation profile, the evaluation configuration interface, included or separate from illustration profile configuration interface in the user interface 200, includes user input fields, as discussed above, that are configured to receive user inputs identifying the amount of system data promised by/expected to be sent by the network service provider, the condition(s) representing an error occurrence (e.g., actual amount of system data received is lower/higher than the inputted amount of data by a predefined value, the actual amount of received system data is having an increasing/decreasing trend for a predefined period of time, etc.).

In some embodiments, the user interface for creating and configuring the evaluation profile is only made available to an authorized user. In some embodiments, when triggering the user interface for creating and configuring the evaluation profile, the network management platform 101 causes a user credential input window or user input field to be presented to request the user to input, for example, a password, a user ID, and/or some other suitable information to verify the identity of the user.

In some embodiments, the network management platform 101 is configured to enable a user (e.g., network administrator on a communication network side and/or a network service provider) to create a configured illustration and/or evaluation profile and then update the amount of system data to be included in the graphical representation based on the illustration profile, the amount of system data to be processed for evaluating the received system data based on the evaluation profile, and/or the amount of system data to be communicated from the network service provider to the network management platform 101 at any time.

In some embodiments, only some authorized users have rights to update and/or configure evaluation profiles. For example, if users having access to the network management platform 101 have varying levels of authority, the network management platform 101 is optionally configured to prevent users that have a level of authority below a preset level of authority from creating an evaluation profile and/or prevent users that have a level of authority below a preset level of authority from modifying or updating a pre-existing evaluation profile. In some embodiments, users having authority to access the network management platform 101 are able to create evaluation profiles that are determined to be original or non-duplicative with pre-existing evaluation profiles. In some embodiments, if a user has a level of authority greater than or equal to a preset level of authority, such a user is allowed by the network management platform 101 to modify or update a pre-existing evaluation profile and/or create a duplicative or overlapping evaluation profile. In some embodiments, the network management platform 101 is configured to allow any user having access to the network management platform to create on-demand or autonomous illustration profiles, but restricts the rights to create evaluation profiles to those having a level of authority greater than or equal to a preset level of authority. Even still, in some embodiments, the network management platform 101 is configured to allow users having access to the network management platform 101 to create on-demand or autonomous illustration profiles, allow only users having a level of authority greater than or equal to a first preset level of authority to create evaluation profiles, and allow only users having a level of authority greater than or equal to a second preset level of authority greater than the first preset level of authority to update or modify a pre-existing evaluation profile. In some embodiments, network management platform 101 is configured to allow only users having a level of authority greater than the level of authority of the user that created the evaluation profile to update and/or modify a pre-existing evaluation profile created by another user. In some embodiments, network management platform 101 is configured to allow only users having a level of authority greater than or equal to the level of authority of the user that created the evaluation profile to update and/or modify a pre-existing evaluation profile created by another user. Rules that limit the authority to create and/or modify evaluation profiles helps to reduce the possibility of creating duplicative evaluation profiles that could lead to extraneous alerts being sent to a same recipient and/or helps to reduce consumption of system resources that could slow the response time and reduce the overall capabilities of the system 100.

In some embodiments, once an evaluation profile is updated, the network management platform 101 records the time of update, which will then be presented to a user viewing the evaluation profile such that when another user wants to configure the same configuration profile, the user will be able to understand that such configuration profile has been previously updated and may not require to be updated again, or the user will be informed that another user has updated or modify the user's own pre-existing evaluation profile.

In some embodiments, if an evaluation profile with the same configuration has already been created, the network management platform 101 causes an alert (e.g., a pop-up window or on-screen message) to be presented to the user and the network management platform 101 will not create the evaluation profile in order to avoid duplicative evaluation profile and the wastage of system resources. In some embodiments, network management platform 101 is configured to cause a submit button in the graphical user interface to be inoperable (e.g., grayed-out or some other indication of inoperability), notifying a user that a pre-existing duplicative evaluation profile exists, and the network management platform 101 will not create the evaluation profile in order to avoid duplicative evaluation profile and the wastage of system resources.

In some embodiments, the network management platform 101 will determine the type of the user (e.g., a VIP user, a user which is in-charge of monitoring critical services, a super admin, etc. based on the input user credentials) and provide an option to allow the user to create the same configuration profile after confirming that the same configuration profile should be created.

In some embodiments, before creating an evaluation profile, the network management platform 101 is configured to cause an alert to be present to the user based on a determination that a pre-existing evaluation profile, which is determined by the network management platform 101 to be similar, based on a comparison between the user's configuration input into the evaluation profile creation interface and any pre-existing evaluation profiles in accordance with at least one rule defining an allowable degree of similarity for generating a new evaluation profile. For example, when the network management platform 101 determines that the user's configuration input into the evaluation profile interface only differs from a pre-existing profile in terms of the amount of system data expected to be received from a network service provider monitoring system 109, the network management platform 101 causes a message to be presented to the user informing the same, and ask whether or not the user wants to configure and/or update the pre-existing evaluation profile instead of creating a new evaluation profile.

In some embodiments, similar to the illustration of data, once an evaluation profile has been created, the network management platform will continuously monitor and evaluate the system data received by the network management platform 101 and/or database 103 based on the evaluation profile. Then, when new system data for the selected network service provider has been received, the network management platform 101 will automatically retrieve the updated system data from the database 103 based on the evaluation profile and update the graphical representation (e.g., the graphical display and/or list of information) based on the updated system data and the illustration profile. Accordingly, in some embodiments, the network management platform 101 provides a graphical representation which continuously monitors and evaluates the received system data in real-time. In some embodiments, the network management platform 101 provides a graphical representation which monitors and evaluates the received system data on-demand.

In some embodiments, whether autonomous or on-demand, if the network management platform 101 determines the amount of system data received by the network management platform 101 and/or the database 103 is different from the configuration defined in the evaluation profile, the network management platform 101 causes an action to be performed such as sending an alert to the user that created the evaluation profile, a network administrator other than the user that created the evaluation profile, a designated recipient of the alert according to the evaluation profile, and/or the network service provider, and/or shifting a network service associated with the problematic network service provider to a network service provided by another network service provider, shifting the one or more network services to another network device, or some other suitable action to maintain or improve the state of the communication network 111 that may be affected by, indicated as being affected by, or assumed to be affected by the unexpected deviation in the expected amount of system data that is received.

In some embodiments, a user may implement a regional monitoring system which also locally monitors the actual amount of system data received, and then uses the locally monitored system data to crosscheck with the system data provided by the network service providers, such that when an error in the amount of system data received is detected, the location of the deviation in the amount of system data received can be processed to determine the cause of the error.

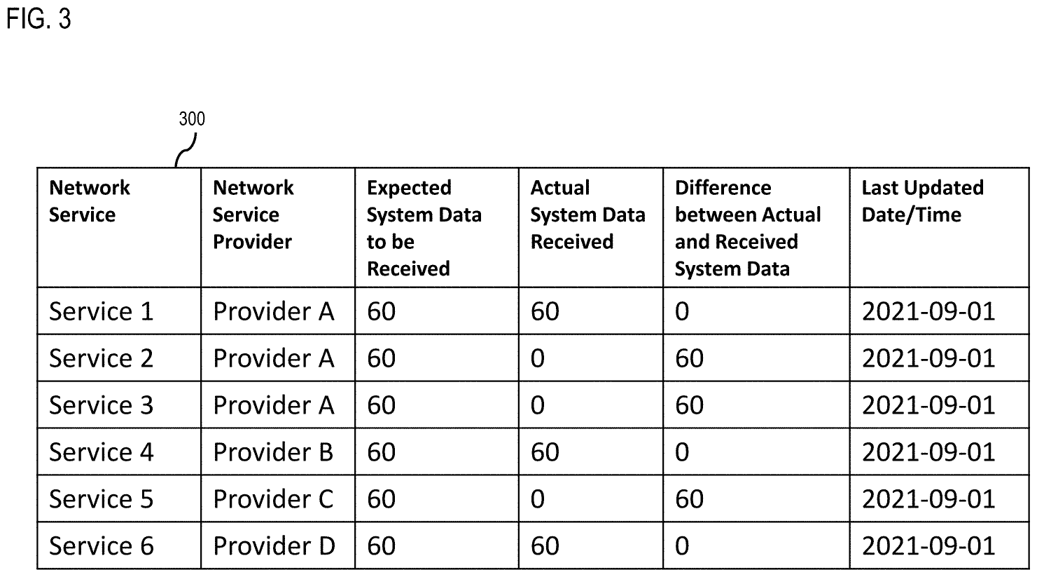

FIG. 3 is a diagram of a graphical user interface 300, in accordance with one or more embodiments. Graphical user interface 300 shows an example of a list of network services provided by multiple network service providers, expected system data that is to be provided by the network service provider for a particular network service, actual system data received from the network service providers, differences between the expected system data to be received and the actual system data received, and the time when the information in the user interface was updated.

In some embodiments, the network services included in the list can include all of the network services that are provided by the plurality of network service providers, network services in a particular geographical location as defined in the evaluation profile and/or illustration profile, network services provided by a particular network service provider as defined in the evaluation profile and/or illustration profile, network services as defined in the evaluation profile and/or illustration profile, or other suitable information as defined in the evaluation profile and/or illustration profile

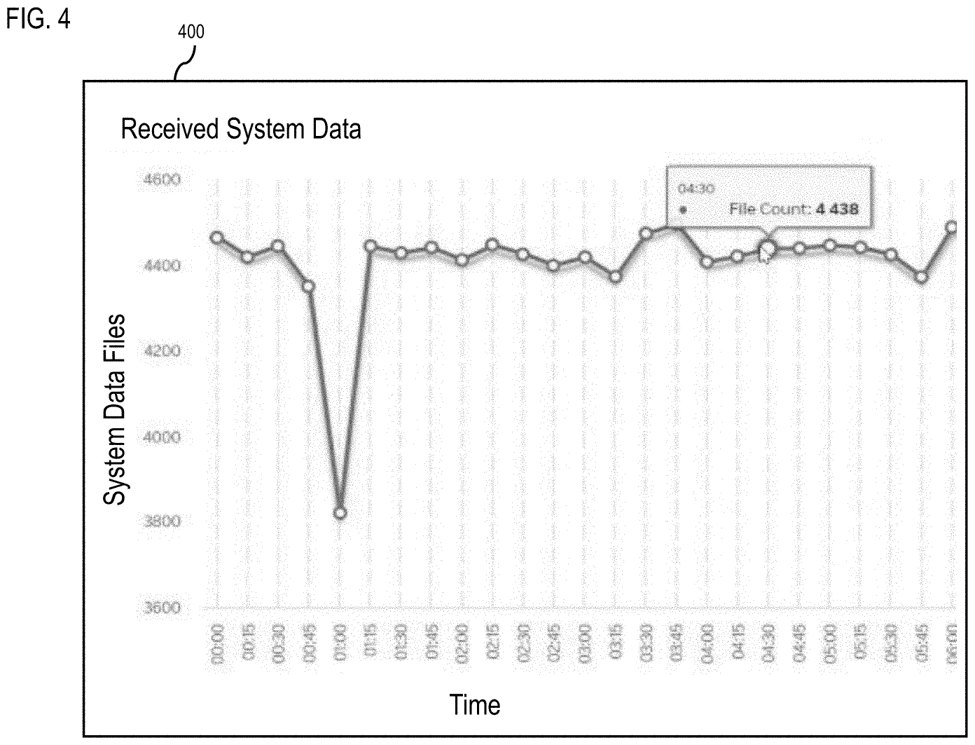

FIG. 4 is a diagram of a graphical user interface 400, in accordance with one or more embodiments. Graphical user interface 400 shows an example of a graph generated and outputted by the network management platform 101 based on an illustration profile created. In this non-limiting example, the graph included in user interface 400 includes detailed information of the amount of system data received for the selected network services, e.g., count of system data files received every 15 minutes from 0:00 (i.e., a start time) to 6:00 (i.e., end time). The time period is capable of being varied based on the network service providers, the type of network service, the location, the technology, etc., as defined in the illustration profile. The graph included in user interface 400 indicates a visible trend of the amount of system data received (e.g., a reducing trend, an increasing trend, etc.), details of the amount of system data received at each time point, or some other suitable information to provide a visual representation of the integrity and completeness of the system data received from the network service provider(s) and/or associated with the network service(s) defined in the illustration profile.

The graph included in this example of user interface 400 is a line graph. In some embodiments, the information provided by way of user interface 400 could also be presented in other forms, such as pie chart, bar graph, histogram, line plot, frequency table, and some other suitable graphical representation as defined in the illustration profile.

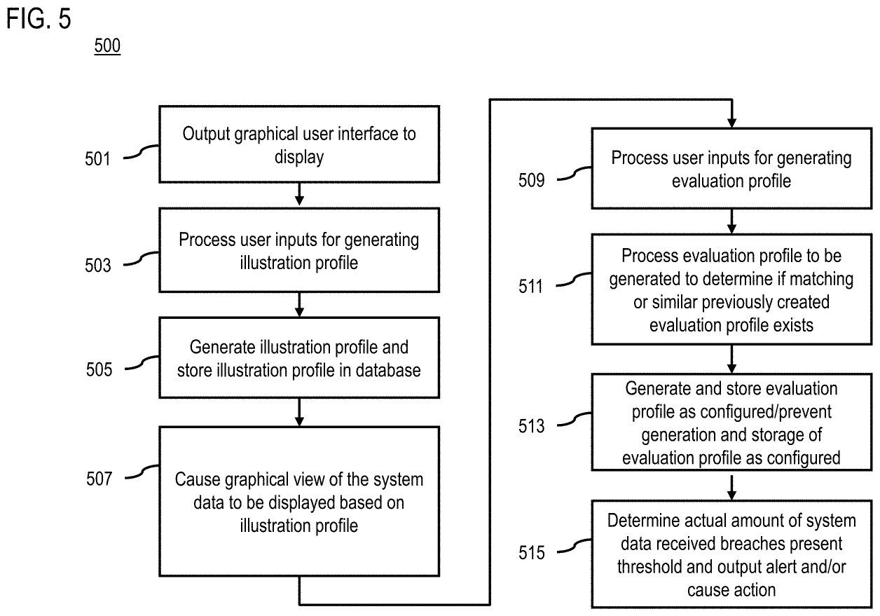

FIG. 5 is a flowchart of a process 500 for illustrating and evaluating data integrity corresponding to a network service provided to a communication network by a network service provider, in accordance with one or more embodiments. In some embodiments, the network management platform 101 (FIG. 1) performs the process 500.

In step 501, a graphical user interface such as graphical user interface 200 is caused to be output by a display.

In step 503, user inputs received by way of the graphical user interface for generating an illustration profile are processed. The user inputs for generating the illustration profile comprise one or more of a selected network service provider name, a selected wireless domain, a selected wireless technology, expected amounts of the system data associated with a network service that are expected to be received from a selected network service provider, time(s) the system data is expected to received, quantity(ies) of values of the system data to be included in a graphical view, a period of time for illustrating values of the system data, a selection of one or more types of graphs for illustrating the values of the system data, an indication two or more types of graphs that are to be output, a geographical region within which the one or more network services are provided to the communication network, or other suitable user input(s) for illustrating the integrity and completeness of system data received from a selected network service provider.

In step 505, the illustration profile is caused to be generated and stored in a database.

In step 507, an instruction to view system data associated with one or more network services provided to the communication network is processed to cause a graphical view of the system data to be displayed based on the illustration profile.

In some embodiments, the graphical view comprises values of the system data and corresponding times the system data was received from a selected network service provider as defined in the illustration profile. In some embodiments, the values of the system data, for example, represent an amount of system data provided to the network operator for monitoring a communication network that is provided by a network operator by combining various network services provided by the selected network service provider. In some embodiments, the graphical view comprises expected amounts of the system data associated with the one or more network services that were expected to be received from the selected network service provider at the corresponding times the system data was received from the selected network service provider as defined in the illustration profile. In some embodiments, the graphical view comprises a graph of the values of the system data over a period of time as defined in the illustration profile. In some embodiments, the graphical view comprises a graph having the quantity of values of the system data for the period of time as defined in the illustration profile. In some embodiments, the graphical view comprises a graph that is a type of graph as defined in the illustration profile. In some embodiments, the graphical view comprises two or more types of graphs as defined in the illustration profile. In some embodiments, the two or more types of graphs are concurrently displayed in a same user interface display. In some embodiments the two or more types of graphs are displayed in different windows or views accessible by way of the user interface display. In some embodiments, the values of the system data included in the graphical display is caused to be limited to those associated with the geographical region as defined in the illustration profile.

In step 509, user inputs received by way of the graphical user interface for generating an evaluation profile are processed. The user inputs for generating the evaluation profile comprise one or more of an expected amount of system data associated with the one or more network services to be provided by the selected network service provider, a period of time to monitor the amount of the system data associated with the one or more network services as the system data is received from the selected network service provider, a variation threshold between the expected amount of the system data received from the selected network service provider and an actual amount of the system data received from the selected network service provider, a geographical region within which one or more network services are provided to the communication network, one or more alert types caused to be output based on the determination that the actual amount of system data received from the selected network service provider breaches the variation threshold, one or more recipients of the alert, one or more recipients of the alert, a time range for outputting the alert, an action that is to be performed in addition to outputting the alert, an action that is to be formed as an alternative to outputting the alert, a time range for performing the action, or some other suitable user input(s) for evaluating the integrity and completeness of system data received from a selected network service provider.

In some embodiments, the time range for outputting the alert is different from the period of time to monitor the actual amount of system data received from the selected network service provider. In some embodiments, the one or more alert types comprising at least one of a text message, an email, a graphical image output to the display, a voice call, a pager message, or some other suitable manner by which an alert is capable of being communicated to a recipient. In some embodiments, the time range for performing the action is different from the period of time to monitor the actual amount of system data received from the selected network service provider and/or different from the time range for outputting the alert. In some embodiments, the variation threshold comprises one or more of greater than or less than the expected amount of the system data received from the selected network service provider. In some embodiments, the variation threshold further comprises a tolerance range.

In some embodiments, the user inputs received for generating the evaluation profile are received by way of the same user interface displayed for receiving the user inputs to generate the illustration profile. In some embodiments, one or more of the user inputs received for generating the evaluation profile are received by way of a different user interface, or a different user interface window, than that displayed for receiving the user inputs to generate the illustration profile. For example, some or all of the user inputs for generating the illustration profile are received via an illustration profile creation interface, some or all of the user inputs for generating the evaluation profile are received via an evaluation profile creation interface separately displayed from the illustration profile creation interface. In some embodiments, some of the user inputs received for generating the illustration profile and some of the user inputs received for generating the evaluation profile are duplicative in the illustration profile creation interface and the evaluation profile creation interface.

In step 511, the evaluation profile to be generated as configured based on the user inputs is processed to determine if a previously created evaluation profile exists in the database matching the evaluation profile to be generated, or a previously created evaluation profile exists having a predetermined quantity of identical parameters in accordance with at least one rule defining a degree of allowable similarity to the evaluation profile to be generated.

In step 513, the evaluation profile to be generated is generated and stored in the database or prevented from being generated. The evaluation profile is generated and stored in the database based on a determination that the evaluation profile is unique (i.e., no previously created evaluation profile exists that is matching the evaluation profile to be generated, or no previously created evaluation profile exists that has more parameter than those allowed to comply with the at least one rule defining the degree of allowable similarity). Alternatively, based on a determination that a previously created evaluation profile in the database is identical or is too similar according to the at least one rule defining the degree of allowable similarity, a message is caused to be displayed indicating the previously created evaluation profile exists in the database and the evaluation profile as configured based on the user inputs is prevented from being generated and stored in the database unless user credentials are input into a user input field requesting authority to generate the evaluation profile are received or changes are made to the user inputs received for generating the evaluation profile. For example, based on a determination that user credentials having at least a preset level of authority among two or more levels of authority are recognized as being input, or enough changes are made to the user inputs received for generating the evaluation profile are made to overcome the determination that an identical evaluation profile and/or the determination that an evaluation profile that is too similar according to the at least one rule defining the degree of allowable similarity exists, the evaluation profile configured based on the user input is then caused to be generated and stored in the database.

In step 515, an alert is caused to be output to the network operator based on a determination that the actual amount of the system data received from the selected network service provider breaches the variation threshold. In some embodiments, the actual amount of system data received from the selected network service provider considered for causing the alert is caused to be limited to those associated with a geographical region as defined in the evaluation profile. In some embodiments, the alert is caused to be output based on the alert type defined in the evaluation profile. In some embodiments, the alert is caused to be communicated to the identified one or more recipients as defined in the evaluation profile. In some embodiments, the alert is caused to be output in the time range for outputting the alert as defined in the evaluation profile.

In some embodiments, in addition to the alert or as an alternative to the alert, some other suitable action is caused to be performed based on a determination that the actual amount of the system data received from the selected network service provider breaches the variation threshold such as shifting a network service associated with the problematic network service provider to a network service provided by another network service provider, shifting the one or more network services to another network device, or some other suitable action to maintain or improve the state of the communication network that may be affected by, indicated as being affected by, or assumed to be affected by an unexpected deviation in the expected amount of system data that is received, as defined in the evaluation profile.

The embodiments discussed herein provide a system and method which make it possible for a network operator to verify the integrity and completeness of system data that is received by the network operator is equal to the amount of system data informed/promised/agreed to by various network service providers that provide one or more network services that the network operator uses to provide a communication network. The discusses system and method also make it possible for a network operator to identify when and why the actual amount of system data informed/promised/agreed to by various network service providers deviates from an expected amount of system data and take action regarding any arrangements with a particular network service provider regarding a failure to supply the expected system data or change network service providers or network devices that are used to provide the one or more network services that are malfunctioning to one or more alternative network service providers and/or one or more alternative network devices to ensure the communication network is operations and available for consumers while reducing redundant alerts and conserving system resources.

FIG. 6 is a functional block diagram of a computer or processor-based system 600 upon which or by which an embodiment is implemented.

Processor-based system 600 is programmed to facilitate illustrating and evaluating data integrity corresponding to a network service provided to a communication network by a network service provider, as described herein, and includes, for example, bus 601, processor 603, and memory 605 components.

In some embodiments, the processor-based system is implemented as a single “system on a chip.” Processor-based system 600, or a portion thereof, constitutes a mechanism for performing one or more steps of facilitating illustration and evaluation of data integrity corresponding to a network service provided to a communication network by a network service provider.

In some embodiments, the processor-based system 600 includes a communication mechanism such as bus 601 for transferring and/or receiving information and/or instructions among the components of the processor-based system 600. Processor 603 is connected to the bus 601 to obtain instructions for execution and process information stored in, for example, the memory 605. In some embodiments, the processor 603 is also accompanied with one or more specialized components to perform certain processing functions and tasks such as one or more digital signal processors (DSP), or one or more application-specific integrated circuits (ASIC). A DSP typically is configured to process real-world signals (e.g., sound) in real time independently of the processor 603. Similarly, an ASIC is configurable to perform specialized functions not easily performed by a more general purpose processor. Other specialized components to aid in performing the functions described herein optionally include one or more field programmable gate arrays (FPGA), one or more controllers, or one or more other special-purpose computer chips.

In one or more embodiments, the processor (or multiple processors) 603 performs a set of operations on information as specified by a set of instructions stored in memory 605 related to facilitating illustration and evaluation of data integrity corresponding to a network service provided to a communication network by a network service provider. The execution of the instructions causes the processor to perform specified functions.

The processor 603 and accompanying components are connected to the memory 605 via the bus 601. The memory 605 includes one or more of dynamic memory (e.g., RAM, magnetic disk, writable optical disk, etc.) and static memory (e.g., ROM, CD-ROM, etc.) for storing executable instructions that when executed perform the steps described herein to facilitate illustrating and evaluating data integrity corresponding to a network service provided to a communication network by a network service provider. The memory 605 also stores the data associated with or generated by the execution of the steps.

In one or more embodiments, the memory 605, such as a random access memory (RAM) or any other dynamic storage device, stores information including processor instructions for facilitating illustration and evaluation of data integrity corresponding to a network service provided to a communication network by a network service provider. Dynamic memory allows information stored therein to be changed. RAM allows a unit of information stored at a location called a memory address to be stored and retrieved independently of information at neighboring addresses. The memory 605 is also used by the processor 603 to store temporary values during execution of processor instructions. In various embodiments, the memory 605 is a read only memory (ROM) or any other static storage device coupled to the bus 601 for storing static information, including instructions, that is not capable of being changed by processor 603. Some memory is composed of volatile storage that loses the information stored thereon when power is lost. In some embodiments, the memory 605 is a non-volatile (persistent) storage device, such as a magnetic disk, optical disk or flash card, for storing information, including instructions, that persists even when the system 600 is turned off or otherwise loses power.

The term “computer-readable medium” as used herein refers to any medium that participates in providing information to processor 603, including instructions for execution. Such a medium takes many forms, including, but not limited to computer-readable storage medium (e.g., non-volatile media, volatile media). Non-volatile media includes, for example, optical or magnetic disks. Volatile media include, for example, dynamic memory. Common forms of computer-readable media include, for example, a floppy disk, a flexible disk, a hard disk, a magnetic tape, another magnetic medium, a CD-ROM, CDRW, DVD, another optical medium, punch cards, paper tape, optical mark sheets, another physical medium with patterns of holes or other optically recognizable indicia, a RAM, a PROM, an EPROM, a FLASH-EPROM, an EEPROM, a flash memory, another memory chip or cartridge, or another medium from which a computer can read. The term computer-readable storage medium is used herein to refer to a computer-readable medium.

An aspect of this description is related to a method, comprising causing, by a processor, a graphical user interface to be output by a display. The graphical user interface comprises a first user input field configured to receive a first user input identifying a network service provider name identifying a selected network service provider of a plurality of network service providers associated with providing one or more network services to a communication network provided by a network operator by way of a network orchestrator communicatively coupled with one or more network devices associated with implementing the one or more network services provided by the plurality of network service providers. The graphical user interface also comprises a second user input field configured to receive a second user input identifying a selected wireless domain of a plurality of wireless domains. The graphical user interface further comprises a third user input field configured to receive a third user input identifying a selected wireless technology of a plurality of wireless technologies. The method also comprises processing the selected network service provider name, the selected wireless domain and the selected wireless technology to generate an illustration profile. The method further comprises causing the illustration profile to be stored in a database. The method additionally comprises processing an instruction to view system data associated with the one or more network services provided to the communication network to cause a graphical view of the system data to be displayed based on the illustration profile. The graphical view comprises values of the system data and corresponding times the system data was received by the network orchestrator from the selected network service provider.

Another aspect of this description is related to an apparatus comprising a processor and a memory having instructions stored thereon that, when executed by the processor, cause the apparatus to cause a graphical user interface to be output by a display. The graphical user interface comprises a first user input field configured to receive a first user input identifying a network service provider name identifying a selected network service provider of a plurality of network service providers associated with providing one or more network services to a communication network provided by a network operator by way of a network orchestrator communicatively coupled with one or more network devices associated with implementing the one or more network services provided by the plurality of network service providers. The graphical user interface also comprises a second user input field configured to receive a second user input identifying a selected wireless domain of a plurality of wireless domains. The graphical user interface further comprises a third user input field configured to receive a third user input identifying a selected wireless technology of a plurality of wireless technologies. The apparatus is also caused to process the selected network service provider name, the selected wireless domain and the selected wireless technology to generate an illustration profile. The apparatus is further caused to cause the illustration profile to be stored in a database. The apparatus is additionally caused to process an instruction to view system data associated with the one or more network services provided to the communication network to cause a graphical view of the system data to be displayed based on the illustration profile. The graphical view comprises values of the system data and corresponding times the system data was received by the network orchestrator from the selected network service provider.

Another aspect of this description is directed to a non-transitory computer readable medium having instructions stored thereon that, when executed by a processor, cause an apparatus to cause a graphical user interface to be output by a display. The graphical user interface comprises a first user input field configured to receive a first user input identifying a network service provider name identifying a selected network service provider of a plurality of network service providers associated with providing one or more network services to a communication network provided by a network operator by way of a network orchestrator communicatively coupled with one or more network devices associated with implementing the one or more network services provided by the plurality of network service providers. The graphical user interface also comprises a second user input field configured to receive a second user input identifying a selected wireless domain of a plurality of wireless domains. The graphical user interface further comprises a third user input field configured to receive a third user input identifying a selected wireless technology of a plurality of wireless technologies. The apparatus is also caused to process the selected network service provider name, the selected wireless domain and the selected wireless technology to generate an illustration profile. The apparatus is further caused to cause the illustration profile to be stored in a database. The apparatus is additionally caused to process an instruction to view system data associated with the one or more network services provided to the communication network to cause a graphical view of the system data to be displayed based on the illustration profile. The graphical view comprises values of the system data and corresponding times the system data was received by the network orchestrator from the selected network service provider.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. A method, comprising:
causing, by a processor, a graphical user interface to be output by a display, the graphical user interface comprising:
a first user input field configured to receive a first user input identifying a network service provider name identifying a selected network service provider of a plurality of network service providers associated with providing one or more network services to a communication network provided by a network operator by way of a network orchestrator communicatively coupled with one or more network devices associated with implementing the one or more network services provided by the plurality of network service providers;
a second user input field configured to receive a second user input identifying a selected wireless domain of a plurality of wireless domains; and
a third user input field configured to receive a third user input identifying a selected wireless technology of a plurality of wireless technologies;
processing the network service provider name identifying the selected network service provider, the selected wireless domain and the selected wireless technology to generate an illustration profile;
causing the illustration profile to be stored in a database; and
processing an instruction to view system data associated with the one or more network services provided to the communication network to cause a graphical view of the system data to be displayed based on the illustration profile,
wherein
the graphical view comprises values of the system data and corresponding times the system data was received by the network orchestrator from the selected network service provider,
the values of the system data represent an amount of system data provided to the network orchestrator for monitoring the communication network,
the amount of system data is a count of system data files received by the network orchestrator from the selected network service provider, and
the graphical view further comprises predefined amounts of system data that were expected to be received by the network orchestrator from the selected network service provider at the corresponding times the system data was received by the network orchestrator from the selected network service provider.

2. (canceled)

3. The method of claim 1, wherein the graphical view comprises a graph of the values of the system data over a period of time.

4. The method of claim 3, wherein
the graphical user interface further comprises:
a fourth user input field configured to receive a fourth user input identifying a quantity of values of the system data to be included in the graphical view; and
a fifth user input field configured to receive a fifth user input identifying the period of time, and
the method further comprises:
processing the fourth user input identifying the quantity of values of the system data and the fifth user input identifying the period of time to include the quantity of values of the system data and the period of time to be included in the illustration profile.

5. The method of claim 4, wherein
the graphical user interface further comprises a sixth user input field configured to receive a sixth user input identifying one or more types of graphs of the values of the system data over the period of time, the one or more types of graphs being at least one of a pie graph, a bar graph, a histogram, a line plot, or a frequency table,
the method further comprises processing the sixth user input to include the identified one or more types of graphs in the illustration profile, and
the graph included in the graphical view corresponds to the identified one or more types of graphs.

6. The method of claim 5, wherein based on a determination that the sixth user input identifies two or more of the types of graphs, the method further comprises:
causing the two or more types of graphs to be concurrently displayed based on the instruction to view system data associated with the one or more network services provided to the communication network.

7. (canceled)

8. The method of claim 1, further comprising:
processing a fourth user input received by way of a fourth user input field identifying the expected amount of system data associated with the one or more network services to be provided to the network orchestrator by the selected network service provider;
processing a fifth user input received by way of a fifth user input field identifying a period of time to monitor the amount of the system data associated with the one or more network services as the system data is received by the network orchestrator from the selected network service provider;
processing a sixth user input received by way of a sixth user input field identifying a variation threshold between the expected amount of the system data received by the network orchestrator from the selected network service provider and an actual amount of the system data received by the network orchestrator from the selected network service provider;
causing an evaluation profile to be generated and stored in the database based on the fourth user input, the fifth user input and the sixth user input; and
causing an alert to be output to the network operator based on a determination that the actual amount of the system data received by the network orchestrator from the selected network service provider breaches the variation threshold.

9. The method of claim 8, wherein the fourth user input field, the fifth user input field and the sixth user input field are included in the graphical user interface.

10. The method of claim 9, wherein
the graphical user interface further comprises a seventh user interface field configured to receive a seventh user input identifying a geographical region within which the one or more network services are provided to the communication network, and
the method further comprises:
processing the seventh user input to include the geographical region in at least one of the illustration profile or the evaluation profile; and
causing at least one of (1) the values of the system data included in the graphical display to be limited to those associated with the geographical region or (2) the actual amount of system data received by the network orchestrator from the selected network service provider considered for causing the alert to be limited to those associated with the geographical region.

11. The method of claim 8, wherein the graphical user interface is an illustration profile creation interface and the fourth user input field, the fifth user input field and the sixth user input field are included in an evaluation profile creation interface separately displayed from the illustration profile creation interface.

12. The method of claim 8, further comprising:
processing a seventh user input received by way of a seventh user input field identifying one or more alert types caused to be output based on the determination that the actual amount of system data received by the network orchestrator from the selected network service provider breaches the variation threshold, the one or more alert types comprising at least one of a text message, an email, a graphical image output to the display, a voice call, or a pager message; and
causing the alert to be output based on the seventh user input.

13. The method of claim 12, further comprising:
processing an eighth user input received by way of an eighth user input field identifying one or more recipients of the alert; and
causing the alert to be communicated to the identified one or more recipients based on the eighth user input.

14. The method of claim 12, further comprising:
processing an eighth user input received by way of an eighth user input field identifying a time range for outputting the alert, the time range for outputting the alert being different from the period of time to monitor the actual amount of system data received by the network orchestrator from the selected network service provider.

15. The method of claim 8, wherein the variation threshold comprises one or more of greater than or less than the expected amount of the system data received by the network orchestrator from the selected network service provider.

16. The method of claim 15, wherein the variation threshold further comprises a tolerance range.

17. The method of claim 8, further comprising:
processing the evaluation profile to determine a previously created evaluation profile exists in the database matching the fourth user input, the fifth user input and the sixth user input;
causing a message to be displayed indicating the previously created evaluation profile exists in the database;
causing a seventh user input field to be displayed configured to receive a seventh user input identifying user credentials; and
preventing the evaluation profile from being generated and stored in the database until user credentials having at least a preset level of authority among two or more levels of authority are recognized as being input as the seventh user input into the seventh user input field.

18. The method of claim 8, further comprising:
causing the network orchestrator to one or more of (1) change provision of the one or more network services provided to the communication network from the selected network service provider to one or more different network service providers of the plurality of network service providers capable of being identified by way of the first user input field or (2) cause provision of the one or more network services provided to the communication network to be shifted to one or more alternative network devices associated with the one or more network services provided by the selected network service provider based on the determination that the actual amount of the system data received by the network orchestrator from the selected network service provider breaches the variation threshold.

19. An apparatus, comprising:
a processor; and
a memory having instructions stored thereon that, when executed by the processor, cause the apparatus to:
cause a graphical user interface to be output by a display, the graphical user interface comprising:
a first user input field configured to receive a first user input identifying a network service provider name identifying a selected network service provider of a plurality of network service providers associated with providing one or more network services to a communication network provided by a network operator by way of a network orchestrator communicatively coupled with one or more network devices associated with implementing the one or more network services provided by the plurality of network service providers;
a second user input field configured to receive a second user input identifying a selected wireless domain of a plurality of wireless domains; and
a third user input field configured to receive a third user input identifying a selected wireless technology of a plurality of wireless technologies;
process the network service provider name identifying the selected network service provider, the selected wireless domain and the selected wireless technology to generate an illustration profile;
cause the illustration profile to be stored in a database; and
process an instruction to view system data associated with the one or more network services provided to the communication network to cause a graphical view of the system data to be displayed based on the illustration profile,
wherein
the graphical view comprises values of the system data and corresponding times the system data was received by the network orchestrator from the selected network service provider,
the values of the system data represent an amount of system data provided to the network orchestrator for monitoring the communication network,
the amount of system data is a count of system data files received by the network orchestrator from the selected network service provider, and
the graphical view further comprises predefined amounts of system data that were expected to be received by the network orchestrator from the selected network service provider at the corresponding times the system data was received by the network orchestrator from the selected network service provider.

20. A non-transitory computer readable medium having instructions stored thereon that, when executed by a processor, cause an apparatus to:
cause a graphical user interface to be output by a display, the graphical user interface comprising:
a first user input field configured to receive a first user input identifying a network service provider name identifying a selected network service provider of a plurality of network service providers associated with providing one or more network services to a communication network provided by a network operator by way of a network orchestrator communicatively coupled with one or more network devices associated with implementing the one or more network services provided by the plurality of network service providers;
a second user input field configured to receive a second user input identifying a selected wireless domain of a plurality of wireless domains; and
a third user input field configured to receive a third user input identifying a selected wireless technology of a plurality of wireless technologies;
process the network service provider name identifying the selected network service provider, the selected wireless domain and the selected wireless technology to generate an illustration profile;
cause the illustration profile to be stored in a database; and
process an instruction to view system data associated with the one or more network services provided to the communication network to cause a graphical view of the system data to be displayed based on the illustration profile,
wherein
the graphical view comprises values of the system data and corresponding times the system data was received by the network orchestrator from the selected network service provider,
the values of the system data represent an amount of system data provided to the network orchestrator for monitoring the communication network,
the amount of system data is a count of system data files received by the network orchestrator from the selected network service provider, and
the graphical view further comprises predefined amounts of system data that were expected to be received by the network orchestrator from the selected network service provider at the corresponding times the system data was received by the network orchestrator from the selected network service provider.

21. The non-transitory computer readable medium of claim 20, wherein the apparatus is further caused to:
process a fourth user input received by way of a fourth user input field identifying the expected amount of system data associated with the one or more network services to be provided to the network orchestrator by the selected network service provider;
process a fifth user input received by way of a fifth user input field identifying a period of time to monitor the amount of the system data associated with the one or more network services as the system data is received by the network orchestrator from the selected network service provider;
process a sixth user input received by way of a sixth user input field identifying a variation threshold between the expected amount of the system data received by the network orchestrator from the selected network service provider and an actual amount of the system data received by the network orchestrator from the selected network service provider;
cause an evaluation profile to be generated and stored in the database based on the fourth user input, the fifth user input and the sixth user input; and
cause an alert to be output to the network operator based on a determination that the actual amount of the system data received by the network orchestrator from the selected network service provider breaches the variation threshold.

22. The apparatus of claim 19, wherein the apparatus is further caused to:
process a fourth user input received by way of a fourth user input field identifying the expected amount of system data associated with the one or more network services to be provided to the network orchestrator by the selected network service provider;
process a fifth user input received by way of a fifth user input field identifying a period of time to monitor the amount of the system data associated with the one or more network services as the system data is received by the network orchestrator from the selected network service provider;
process a sixth user input received by way of a sixth user input field identifying a variation threshold between the expected amount of the system data received by the network orchestrator from the selected network service provider and an actual amount of the system data received by the network orchestrator from the selected network service provider;
cause an evaluation profile to be generated and stored in the database based on the fourth user input, the fifth user input and the sixth user input; and
cause an alert to be output to the network operator based on a determination that the actual amount of the system data received by the network orchestrator from the selected network service provider breaches the variation threshold.
